(19) United States
(12) Patent Application Publication
(10) Pub. No.: US 2003/0161932 A1
(43) Pub. Date: Aug. 28, 2003

(54) Dispensing a beverage

(75) Inventors: Iain Wallace Anderson, Staffordshire (GB); Peter Thomas Foster, Staffordshire (GB); Stuart William Molzahn, Derbyshire (GB); Stephen Paul Smith, Derbyshire (GB); Wendy Gladys Box, Staffordshire (GB); Rachel Joanna Galt, Staffordshire (GB); David Edwin Quain, Staffordshire (GB); Robert Alan Wright, Derbyshire (GB)

Correspondence Address: BAKER & BOTTS, 30 ROCKEFELLER PLAZA, NEW YORK, NY, 10112

(73) Assignee: Coors Worldwide Inc., Golden, CO

(21) Appl. No.: 10/339,234

(22) Filed: Jan. 9, 2003

Related U.S. Application Data
(63) Continuation-in-part of application No. 09/700,512, filed on Jan. 12, 2001.
Application No. 09/700,512 is a 371 of international application No. PCT/GB99/01551, filed on May 14, 1999.

(30) Foreign Application Priority Data
May 15, 1998 (GB) 9810309.6
Dec. 23, 1998 (GB) 9828321.1
Dec. 23, 1998 (GB) 9828317.9
Jan. 19, 1999 (GB) 9901018.3

(51) Int. Cl. C12G 1/00

(52) U.S. Cl. 426/592

(57) ABSTRACT

A method of dispensing a draught beverage which may be alcoholic, for example a lager, and having a water content and a dissolved gas content in which the beverage which may be prior chilled, issues into a glass 2 from a nozzle 3 supplied by beverage supply line 4. Mechanical shear is induced in the beverage in the glass 2 by rotating paddles 23 of a stirring device 21 driven by a motor 24. The occurrence of shear can cause nucleation sites to develop in the glass at which sites gas bubbles can form and encourage the formation of ice in the beverage.

### RELATED INVENTIONS

This application is a continuation-in-part of patent application serial number 700512 which is the derived from international patent application number PCT/GB99/01551 filed May 14, 1999 and a continuation-in-part of patent application serial number 150463 which is derived from international patent application PCT/GB99/03824) filed Nov. 17, 1999.

### FIELD OF THE INVENTION

This invention concerns a method for dispensing a draught beverage, more particularly for dispensing a cooled draught beverage, apparatus for use in dispensing the beverage and the dispensed beverage.

### SUMMARY OF THE INVENTION

The present invention provides a method of dispensing a beverage, said method comprising providing a vessel, cooling the beverage, delivering the beverage into the vessel and transmitting energy into the beverage so as to provide nucleation sites in the beverage where ice forms. The beverage may be cooled prior to being delivered into the vessel, after being delivered into the vessel. The energy may be transmitted into the beverage after it has been delivered into the vessel or while it is being delivered into the vessel, or before it is transmitted into the vessel.

The energy may be transmitted into the beverage by means of a stirrer, which is preferably driven. Alternatively the energy may be transmitted into the beverage by means of shaking the beverage. Preferably the shaking is arranged to produce mechanical shear in the beverage. Preferably a lid is placed over the vessel to retain the beverage in the vessel during the shaking.

The energy may be transmitted into the beverage by rotating the vessel. Preferably the vessel is rotated about an axis in a direction which is reversed so as to produce oscillation of the vessel about the axis. Preferably the oscillation is through an angle of from substantially 5⁰ to substantially 720⁰. Preferably the vessel is rotated about an axis which is substantially vertical. Preferably the vessel has a central axis and the rotation is about said axis. Alternatively the rotation may be about an axis of rotation which is not coincident with said central axis, in which case said axes are preferably both substantially vertical.

In one embodiment the vessel is rotated about an axis of rotation and the beverage is delivered into the vessel by means of a nozzle which is located on said axis of rotation. Alternatively the nozzle may be rotated about the axis of rotation with the vessel.

The energy may be transmitted into the beverage by means of sonic vibration. Preferably said vibration is at ultrasound frequencies. Preferably said vibration has a frequency of at least 20 kHz. Alternatively said vibration may be at audible frequencies.

Preferably the vibration is transmitted to the vessel via a coupling medium, which may be placed in contact with the base of the vessel.

Preferably the energy is transmitted into the beverage by means of movement of the vessel which is arranged to produce mechanical shear of the beverage.

Preferably the beverage includes a water content and the ice forms from said water content. Preferably the beverage contains a dissolved gas content and the transmission of energy into the beverage is arranged to promote the formation of bubbles of said gas in the beverage which form the nucleation sites. Said gas may be carbon dioxide, or nitrogen.

Preferably the beverage is alcoholic, more preferably selected from the group consisting of beer and cider.

The energy may be transmitted into the beverage by means of light, for example laser light. Alternatively the energy may be transmitted into the beverage by vibrating the vessel, for example by striking the vessel or by placing the vessel down on a solid surface. Alternatively the energy may be transmitted into the beverage by heating the beverage, for example by means of a heater which is inserted into the beverage.

The present invention further provides apparatus for dispensing a beverage, the apparatus comprising cooling means for cooling the beverage, a nozzle for delivering the beverage into a vessel and an energy source arranged to transmit energy into the beverage so as to provide nucleation sites in the beverage where ice can form.

The energy source may comprise a stirrer arranged to transmit the energy into the beverage by stirring the beverage. Preferably the apparatus further comprises driving means for driving the stirrer.

The energy source may comprise shaking means arranged to transmit the energy into the beverage by means of shaking the beverage. Preferably the shaking is arranged to produce mechanical shear in the beverage. the energy source comprises a stirrer arranged to transmit the energy into the beverage by stirring the beverage. Preferably the apparatus comprises a lid arranged to be placed over the vessel to retain the beverage in the vessel during the shaking.

The energy source may comprise rotating means arranged to transmit energy into the beverage by rotating the vessel. Preferably the rotating means defines an axis and is arranged to rotate the vessel about the axis in a direction which is reversed so as to produce oscillation of the vessel about the axis. The rotating means may be arranged to rotate the vessel about an axis of rotation which is not coincident with, or which is coincident with, said central axis. Preferably said axes are both substantially vertical. Preferably the rotating means is arranged to rotate the vessel about an axis of rotation and the nozzle is located on said axis of rotation. Alternatively the nozzle may be arranged to rotate about the axis of rotation. Preferably the rotating means is further arranged to rotate the vessel about said central axis.

The energy source may be arranged to transmit the energy into the beverage by means of sonic vibration. Said vibration is preferably at ultrasound frequencies, more preferably at a frequency of at least 20 kHz. Alternatively said vibration may be at audible frequencies. The apparatus may further comprise a coupling medium arranged to transmit the vibration to the vessel. Preferably the vessel has a base and the coupling medium is arranged to be in contact with the base.

The energy source may be arranged to transmit the energy into the beverage by means of movement of the vessel which is arranged to produce mechanical shear of the beverage.

The energy source may comprise a light source arranged to transmit the energy into the beverage by means of light. Preferably the light is laser light. Alternatively the energy source may comprise a vibrator arranged to transmit the energy into the beverage by vibrating the vessel. Alternatively the energy source may comprise a heater arranged to transmit the energy into the beverage by heating the beverage. Preferably the heater is arranged to be inserted into the beverage.

Attention is drawn to two International patent applications, namely International Application No. PCT/GB99/03824 (published under No. WO 01/36582) and International Application No. PCT/GB99/01551 (published under No.WO 99/60092). Any individual feature or any combination of such features of any beverage disclosed in either of those International applications, and any method or apparatus or part of any method or apparatus disclosed in either of those International applications, may be utilised in the dispense of beverage which is the subject of this current application.

Preferred embodiments of the invention will now be further described, by way of example, with reference to the accompanying drawings.

### BRIEF DESCRIPTION OF THE DRAWINGS

FIG. 1 is a diagrammatic side view of an apparatus according to a first embodiment of the invention;

FIG. 2 is a diagrammatic side view of an apparatus according to the second embodiment of the invention;

FIG. 3 is a diagrammatic side view of an apparatus according to a third embodiment of the invention;

FIG. 4 is a diagrammatic side view of an apparatus according to a fourth embodiment of the invention;

FIG. 5 is a diagrammatic side view of an apparatus according to a fifth embodiment of the invention;

FIG. 6 is a diagrammatic side view of an apparatus according to a sixth embodiment of the invention; and

FIG. 7 is a diagrammatic side view of an apparatus according to a seventh embodiment of the invention.

### DESCRIPTION OF THE PREFERRED EMBODIMENTS

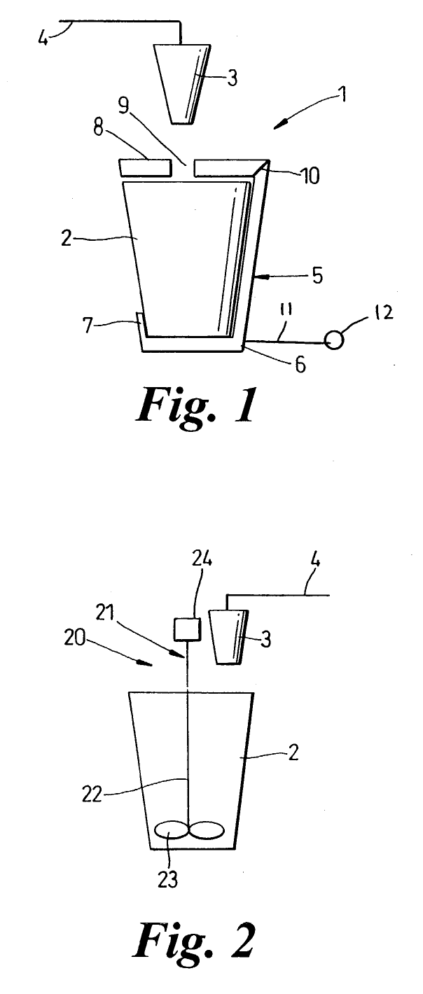

FIG. 1 shows an apparatus 1 suitable for filling a drinking vessel in the form of a glass 2 with a draught beverage. The apparatus 1 comprises a beverage delivery or dispense nozzle 3 which is connected to a draught beverage supply line 4. The apparatus further comprises a driven device 5 for shaking the glass 2. The device 5 comprises an arm 6 which securely holds the base of the glass 2 by means of lip 7. The device 5 further comprises a lid 8 which defines a channel 9 through which the beverage may flow from the nozzle 3 into the glass 2. If desired, the channel 9 may be selectively closeable and openable. The lid 8 is provided with a hinge 10 to enable the glass 2 to be inserted into the device 5. The arm 6 is connected via a link 11 to a motor 12 which is arranged to shake the glass.

The beverage supply line 6 is connected to a source 13 of draught beverage via a cooler unit 14 which is arranged to supercool the beverage to below the freezing point of water. The beverage contains a dissolved gas content and, in this case, is lager.

In order to dispense a beverage, the glass 2 is placed on the arm 6, and the required volume of beverage is dispensed into the glass. The glass is then shaken by the motor 12 in such a manner as to induce mechanical shear in the beverage. The mechanical shear creates nucleation sites wherein the dissolved gas content forms bubbles in the beverage. These bubbles promote the formation of free-floating ice crystals out of the water content of the beverage, which both serve to keep the beverage cool and provide an attractive visual effect.

FIG. 2 shows an apparatus 20 according to a second embodiment of the invention suitable for filling the glass 2 with draught beverage using the beverage nozzle 3 connected to the draught beverage supply line 4 as described with reference to FIG. 1. The apparatus 20 further comprises a stirring system 21 for inducing mechanical shear in the beverage. The stirring system 21 comprises a stirring device 22 which is provided with two paddles 23. The stirring system 21 further comprises a motor 24 which propels the stirring device in such a manner as to stir the beverage in the vessel thereby to induce mechanical shear in the beverage. The mechanical shear has the effect of promoting the formation of bubbles and ice crystals as in the first embodiment.

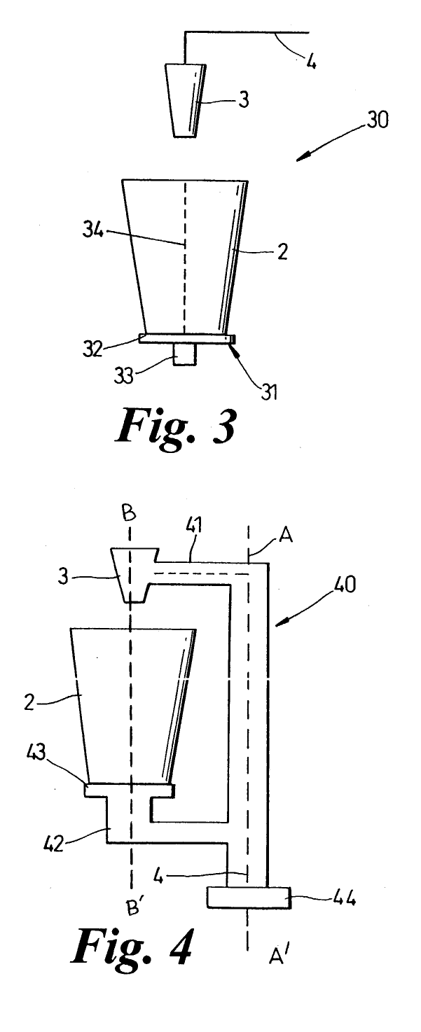

FIG. 3 shows an apparatus 30 according to a third embodiment of the invention suitable for filling the glass 2 with draught beverage using the beverage nozzle 3 connected to the beverage supply line 4 as described with reference to FIG. 1. The apparatus 30 further comprises a platform 31 for having an upper surface 32 on which the base of the glass 2 rests. The platform 31 is provided with a motor 33 which is arranged to cause the platform 31 to oscillate in rotation about an axis 34 which is perpendicular to the surface 32 of the platform 31. A securing mechanism can be provided to detachably secure the glass 2 to the platform 31. The oscillation of the platform 31 is arranged to agitate the beverage in the glass 2 and induce mechanical shear in it. If desired, the platform 31 may be provided with a recessed surface in which recess the glass 2 may sit securely.

The platform 31 may oscillate through any desired angle, for example an angle of oscillation may be in the range of substantially 5° to substantially 720°.

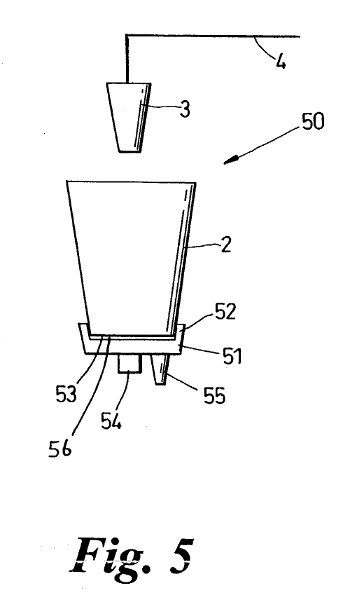

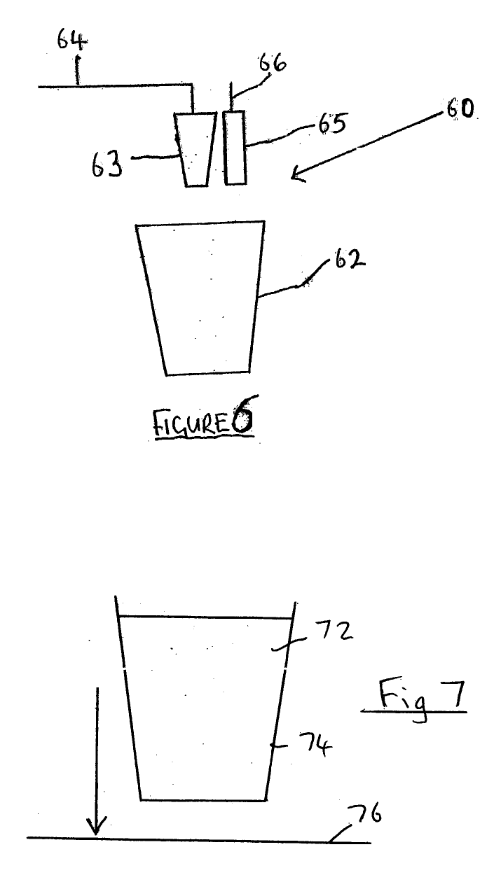

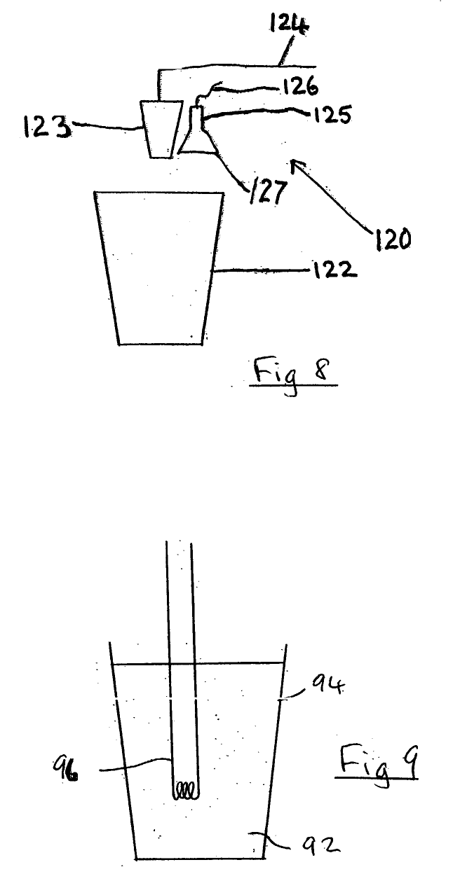

With reference to FIG. 4 there is shown an apparatus 40 according to a fourth embodiment of the invention suitable for filling the glass 2 with draught beverage using the beverage nozzle 3 connected to the beverage supply line 4 as described with reference to FIG. 1. The apparatus 40 further comprises a font 41 which includes an arm 42 which supports a platform 43 on which the glass rests. The font 41 further comprises the beverage nozzle 3 which is supported over the platform 43. The arm 42 and nozzle 3 are supported on a support pillar 45 which is connected to a drive motor 44. The drive motor 44 rotates the entire font 41 about a vertical axis A-A′ such that the platform 42 and the nozzle 3 rotate about the same axis A-A¹. A securing mechanism can be provided to detachably secure the glass 2 to the platform 42. The rotation of the platform 43 is transmitted to the beverage in the vessel, causing agitation and rotation thereof, and can induce mechanical shear in the beverage in the glass 2. If desired, the driving means 44 may be arranged to be above the glass 2. Also platform 42 may be arranged to rotate about a central vertical axis B-B′ thereof parallel to axis A-A′.

The rotation of the font 41 and of the platform 43 can be continuous, or they can be oscillatory as described above with reference to FIG. 3.

Referring to FIG. 5, there is shown an apparatus 50 according to a fifth embodiment of the invention suitable for filling the glass 2 with draught beverage using the beverage nozzle 3 connected to the draught beverage supply line 4 described above with reference to FIG. 1. The apparatus 50 further comprises a rotatable platform 51 which supports the glass 2. Platform 51 comprises a lip 52 which forms a recess 53 in which water 56 is present. Platform 51 is rotated by means of a motor 54. The platform 51 is further provided with an ultrasound generator 55. The water 56 in recess 53 provides an ultrasound coupling to the glass 2.

In use the beverage is dispensed into the glass 2 while the platform 51 is rotated. Then after the beverage has been dispensed and while the platform is still rotating, the ultrasound generator 55 is activated and ultrasound vibrations are transmitted up through the platform 51 and the water 56 into the glass and from there into the beverage. The rotation of the platform 51 (which may be about a central vertical axis thereof) together with the effect of the ultrasound on the beverage in the glass 2 can induce mechanical shear in the beverage.

If desired, recess 53 may contain a gel instead of water. Also motor 52 need not be arranged so that the axis of rotation of the platform 51 is coincident with the centre of the glass 2.

Whilst the ultrasound generator 55 may emit ultrasound at any desired frequency, preferably it is at least substantially 20 kHz.

FIG. 6 shows an apparatus 60 according to a sixth embodiment of the invention, suitable for filling a drinking vessel or glass 62 with a draught beverage. The apparatus 60 possesses a beverage nozzle 63 which is connected to a draught beverage supply line 64 similar to that described above with reference to FIG. 1. The apparatus is also provided with a laser light source 65 which is connected to a power supply 66. The light from light source 65 transmits laser light which irradiates the beverage in the glass 62 both while it is being dispensed and after it has been dispensed, and promotes nucleation within that beverage.

The light source 65 need not be provided vertically above the glass 62 but may optionally be provided at one side or below.

FIG. 8 shows an apparatus 120 according to a eighth embodiment of the invention, suitable for filling a drinking vessel or glass 122 with a draught beverage. The apparatus 120 comprises a beverage nozzle 123 which is connected to a beverage supply line 124 similar to that described above with reference to FIG. 1. The apparatus further comprises sound generation means 125 which is connected to a power supply 126 and comprises a loudspeaker 127 arranged to transmit sound downwards into the beverage. The sound is at the high end of the audible frequency range. The beverage is cooled to a desired temperature just before it issues from the nozzle 123.

If desired the sound generation means 125 can be deployed at the side of the glass 122 or below it.

Subjecting the beverage to audible sound encourages gas bubbles to appear in the beverage in the vessel 122 and provide nucleation sites encouraging formation of ice at the sites in the beverage in the vessel.

We claim:

1. A method of dispensing a beverage, said method comprising providing a vessel, cooling the beverage, delivering the beverage into the vessel and transmitting energy into the beverage so as to provide nucleation sites in the beverage where ice forms.

2. A method according to claim 1 wherein the beverage is cooled prior to being delivered into the vessel.

3. A method according to claim 1 wherein the beverage is cooled after being delivered into the vessel,

4. A method according to claim 1 wherein the energy is transmitted into the beverage after it has been delivered into the vessel.

5. A method according to claim 1 wherein the energy is transmitted into the beverage while it is being delivered into the vessel.

6. A method according to claim 1 wherein the energy is transmitted into the beverage by means of a stirrer.

7. A method according to claim 6 wherein the stirrer is driven.

8. A method according to claim 1 wherein the energy is transmitted into the beverage by means of shaking the beverage.

9. A method according to claim 8 wherein the shaking is arranged to produce mechanical shear in the beverage.

10. A method according to claim 9 comprising placing a lid over the vessel to retain the beverage in the vessel during the shaking.

11. A method according to claim 10 wherein the energy is transmitted into the beverage by rotating the vessel.

12. A method according to claim 11 wherein the vessel is rotated about an axis in a direction which is reversed so as to produce oscillation of the vessel about the axis.

13. A method according to claim 12 wherein the oscillation is through an angle of from substantially 5⁰ to substantially 720⁰.

14. A method according to claim 11 wherein the vessel is rotated about an axis which is substantially vertical.

15. A method according to claim 11 wherein the vessel has a central axis and the rotation is about said axis.

16. A method according to claim 11 wherein the vessel has a central axis and the rotation is about an axis of rotation which is not coincident with said central axis.

17. A method according to claim 16 wherein said axes are both substantially vertical.

18. A method according to claim 11 wherein the vessel is rotated about an axis of rotation and the beverage is delivered into the vessel by means of a nozzle which is located on said axis of rotation.

19. A method according to claim 16 wherein the beverage is delivered into the vessel by means of a nozzle which is rotated about the axis of rotation with the vessel.

20. A method according to claim 16 wherein the vessel is also rotated about said central axis.

21. A method according to claim 1 wherein the energy is transmitted into the beverage by means of sonic vibration.

22. A method according to claim 21 wherein said vibration is at ultrasound frequencies.

23. A method according to claim 22 wherein said vibration has a frequency of at least 20 kHz.

24. A method according to claim 21 wherein said vibration is at audible frequencies.

25. A method according to claim 21 wherein the vibration is transmitted to the vessel via a coupling medium.

26. A method according to claim 25 wherein the vessel has a base and the coupling medium is placed in contact with the base.

27. A method according to claim 1 wherein the energy is transmitted into the beverage by means of movement of the vessel which is arranged to produce mechanical shear of the beverage.

28. A method according to claim 1 wherein the beverage includes a water content and the ice forms from said water content.

29. A method according to claim 1 wherein the beverage contains a dissolved gas content and the transmission of energy into the beverage is arranged to promote the formation of bubbles of said gas in the beverage which form the nucleation sites.

30. A method according to claim 29 wherein said gas is carbon dioxide.

31. A method according to claim 29 wherein said gas is nitrogen.

32. A method according to claim 1 wherein the vessel is a drinking vessel.

33. A method according to claim 32 wherein the drinking vessel is a glass.

34. A method according to claim 1 wherein the beverage is alcoholic.

35. A method according to claim 34 wherein the beverage is selected from the group consisting of beer and cider.

36. A method according to claim 1 wherein the energy is transmitted into the beverage by means of light.

37. A method according to claim 36 wherein the light is laser light.

38. A method according to claim 1 wherein the energy is transmitted into the beverage by vibrating the vessel.

39. A method according to claim 1 wherein the energy is transmitted into the beverage by striking the vessel.

40. A method according to claim 1 wherein the energy is transmitted into the beverage by placing the vessel down on a solid surface.

41. A method according to claim 1 wherein the energy is transmitted into the beverage by heating the beverage.

42. A method according to claim 41 wherein the beverage is heated by means of a heater which is inserted into the beverage.

43. Apparatus for dispensing a beverage, the apparatus comprising cooling means for cooling the beverage, a nozzle for delivering the beverage into a vessel and an energy source arranged to transmit energy into the beverage so as to provide nucleation sites in the beverage where ice can form.

44. Apparatus according to claim 43 wherein the cooling means is arranged to cool the beverage before it is delivered into the vessel.

45. Apparatus according to claim 43 wherein the cooling means is arranged to cool the beverage after it is delivered into the vessel,

46. Apparatus according to claim 43 wherein the energy source is arranged to transmit the energy into the beverage after it has been delivered into the vessel.

47. Apparatus according to claim 43 wherein the energy source is arranged to transmit the energy into the beverage while it is being delivered into the vessel.

48. Apparatus according to claim 43 wherein the energy source comprises a stirrer arranged to transmit the energy into the beverage by stirring the beverage.

49. Apparatus according to claim 44 further comprising driving means for driving the stirrer.

50. Apparatus according to claim 43 wherein the energy source comprises shaking means arranged to transmit the energy into the beverage by means of shaking the beverage.

51. Apparatus according to claim 50 wherein the shaking is arranged to produce mechanical shear in the beverage.

52. Apparatus according to claim 50 comprising a lid arranged to be placed over the vessel to retain the beverage in the vessel during the shaking.

53. Apparatus according to claim 43 wherein the energy source comprises rotating means arranged to transmit energy into the beverage by rotating the vessel.

54. Apparatus according to claim 53 wherein the rotating means defines an axis and is arranged to rotate the vessel about the axis in a direction which is reversed so as to produce oscillation of the vessel about the axis.

55. Apparatus according to claim 54 wherein the oscillation is through an angle of from substantially 5⁰ to substantially 720⁰.

56. Apparatus according to claim 54 wherein the rotating means is arranged to rotate the vessel about an axis which is substantially vertical.

57. Apparatus according to claim 53 for dispensing a beverage into a vessel having a central axis, wherein the rotating means is arranged to rotate the vessel about said central axis.

58. Apparatus according to claim 53 for dispensing a beverage into a vessel having a central axis, wherein the rotating means is arranged to rotate the vessel about an axis of rotation which is not coincident with said central axis.

59. Apparatus according to claim 58 wherein said axes are both substantially vertical.

60. Apparatus according to claim 53 wherein the rotating means is arranged to rotate the vessel about an axis of rotation and the nozzle is located on said axis of rotation.

61. Apparatus according to claim 53 wherein the rotating means is arranged to rotate the vessel about an axis of rotation and the nozzle is arranged to rotate about the axis of rotation.

62. Apparatus according to claim 58 wherein the rotating means is further arranged to rotate the vessel about said central axis.

63. Apparatus according to claim 43 wherein the energy source is arranged to transmit the energy into the beverage by means of sonic vibration.

64. Apparatus according to claim 63 wherein said vibration is at ultrasound frequencies.

65. Apparatus according to claim 64 wherein said vibration has a frequency of at least 20 kHz.

66. Apparatus according to claim 64 wherein said vibration is at audible frequencies.

67. Apparatus according to claim 63 further comprising a coupling medium arranged to transmit the vibration to the vessel.

68. Apparatus according to claim 67 wherein the vessel has a base and the coupling medium is arranged to be in contact with the base.

69. Apparatus according to claim 43 wherein the energy source is arranged to transmit the energy into the beverage by means of movement of the vessel which is arranged to produce mechanical shear of the beverage.

70. Apparatus according to claim 43 wherein the energy source comprises a light source arranged to transmit the energy into the beverage by means of light.

71. Apparatus according to claim 70 wherein the light is laser light.

72. Apparatus according to claim 1 wherein the energy source comprises a vibrator arranged to transmit the energy into the beverage by vibrating the vessel.

73. Apparatus according to claim 43 wherein the energy source is a heater arranged to transmit the energy into the beverage by heating the beverage.

74. Apparatus according to claim 73 wherein the heater is arranged to be inserted into the beverage.
